(19) United States
(12) Patent Application Publication
(10) Pub. No.: US 2023/0295986 A1
(43) Pub. Date: Sep. 21, 2023

(54) Curtain Assembly and Assembling Method Thereof

(71) Applicant: ALION HOME INC., La Puente, CA (US)

(72) Inventor: Guangtian WANG, Hacienda Heights, CA (US)

(21) Appl. No.: 17/836,824

(22) Filed: Jun. 9, 2022

Related U.S. Application Data
(63) Continuation-in-part of application No. 17/696,848, filed on Mar. 16, 2022.

(51) Int. Cl. E06B 9/66; E06B 9/42; E06B 9/78

(52) U.S. Cl. CPC E06B 9/66; E06B 9/42; E06B 9/78; E06B 2009/425; E06B 2009/785

(57) ABSTRACT

A curtain assembly includes a curtain fabric, an upper supporting shaft, a lower supporting shaft, first through fourth coupling member and a connecting cord. The connecting cord sequentially extends between the first coupling member and the second coupling member to form a handle loop. The connecting cord passing through the first coupling member is arranged to pass through the coupling member and extend around the curtain fabric and connect with an external support. The connecting cord passing through the second coupling member is arranged to pass through the fourth coupling member extend around the curtain fabric connect with an external support. The curtain assembly can be operated between a shading position and a retracted position, wherein in the shading position, the curtain fabric is fully extended. In the retracted position, the curtain fabric is retracted to form a roll.

### CROSS REFERENCES OF RELATED APPLICATION

This is a Continuation-in-Part of a non-provisional application having an application Ser. No. 17/696,848 and a filing date of Mar. 16, 2022.

### BACKGROUND OF THE PRESENT INVENTION

### Field of Invention

The present invention relates to a curtain assembly, and more particularly to a curtain assembly which is simple to set up and does not utilize pulleys for actuating retraction of a curtain fabric.

### Description of Related Arts

A conventional curtain assembly typically comprises a top supporting bar, a curtain member connected to the top supporting bar, and a curtain retraction system installed in the top supporting bar for releasing and retracting the curtain member. Conventionally, the curtain retraction system comprises a plurality of connecting strings engaging with a plurality of pulleys mounted on the top supporting bar. The connecting strings are connected to the curtain member so that when the connecting strings are pulled, the curtain member is retracted toward the top supporting bar. The curtain member may be configured as a curtain fabric or configured as comprising a plurality of shade panels.

There are several disadvantages in associated with the above-mentioned conventional curtain assembly. First, almost all conventional curtain assemblies utilize some sort of pulleys for retracting the curtain member. This makes the entire curtain assembly difficult to assemble and maintain. Overtime, the pulleys may not function as designed but it may be difficult for a user to replace just the pulleys. As a result, the entire curtain assembly may need to be replaced. Second, it is difficult to assemble the above-mentioned curtain assembly particularly in outdoor environment. When a user would like to set up a simple curtain assembly in outdoor environment for temporary use (such as a picnic), the above-mentioned curtain assembly is simply not suitable. The user may need to set up a tent or outdoor canopy for providing shade. However, such tent or canopy do not provide freely retractable curtain member as a feature.

As a result, there is a need to provide a curtain assembly which is simple to set up and does not utilize pulleys for actuating retraction of a curtain fabric.

### SUMMARY OF THE PRESENT INVENTION

Certain variations of the present invention provide a curtain assembly which is simple to set up and does not utilize pulleys for actuating retraction of a curtain fabric.

In one aspect of the present invention, it provides a curtain assembly, comprising:
a curtain fabric having a top edge portion, a bottom edge portion, and two side edge portions extending between the top edge portion and the bottom edge portion;
a upper supporting shaft coupled to the top edge portion, the upper supporting shaft having a first supporting end portion, a second supporting end portion, a first coupling hole and a second coupling hole formed on the first supporting end portion and the second supporting end portion respectively;
a lower supporting shaft coupled to the bottom edge portion of the curtain fabric, the lower supporting shaft having a third supporting end portion and a fourth supporting end portion; and
a connecting cord having a first connecting end portion affixed to the third supporting end portion of the lower supporting shaft, and a second connecting end portion affixed to the fourth supporting end portion of the lower supporting shaft, the connecting cord sequentially extending from the third supporting end portion along the corresponding side edge portion of the curtain fabric and repetitively pass through the first coupling hole to form a handle loop, the connecting cord passing through the first coupling hole further extending along the top edge portion of the curtain fabric and pass through the second coupling hole, the connecting cord passing through the second coupling hole further extending along the corresponding side edge portion of the curtain fabric and being affixed on the lower supporting shaft,
the curtain assembly being operated between a shading position and a retracted position, wherein in the shading position, the curtain fabric is fully extended between the upper supporting shaft and the lower supporting shaft, wherein in the retracted position, the handle loop is pulled and retained to pull the lower supporting shaft toward the upper supporting shaft so as to allow the curtain fabric to be retracted.

In another aspect of the present invention, it provides a method of manufacturing a curtain assembly, comprising the steps of:
affixing an upper supporting shaft and a lower supporting shaft to a top edge portion and a bottom edge portion of a curtain fabric respectively;
affixing a first connecting end portion of a connecting cord to a third supporting end portion of a lower supporting shaft;
extending the connecting cord along a side edge portion of the curtain fabric 10 to repetitively pass through a first coupling hole of the upper supporting shaft to form a handle loop;
extending the connecting cord along the top edge portion of the curtain fabric to pass through the second coupling hole of the upper supporting shaft; and
downwardly extending the connecting cord along a corresponding side edge portion of the curtain fabric, and affixing a second connecting end portion of the connecting cord to a fourth supporting end portion of the lower supporting shaft to form the curtain assembly.

In another aspect of the present invention, it provides a method of manufacturing a curtain assembly, comprising the steps of:
affixing an upper supporting shaft and a lower supporting shaft to a top edge portion and a bottom edge portion of a curtain fabric respectively;
affixing a first connecting end portion of a connecting cord to a third supporting end portion of a lower supporting shaft;
extending the connecting cord along a side edge portion of the curtain fabric to repetitively pass through a first coupling hole of the upper supporting shaft to form a handle loop, wherein the first coupling hole may be formed in a first extender ring of the upper supporting shaft;
extending the connecting cord along the top edge portion of the curtain fabric to pass through the second coupling hole of the upper supporting shaft, wherein the second coupling hole may be formed in a second extender ring of the upper supporting shaft; and
downwardly extending the connecting cord along a corresponding side edge portion of the curtain fabric, and affixing a second connecting end portion of the connecting cord to a fourth supporting end portion of the lower supporting shaft to form the curtain assembly.

In another aspect of the present invention, it provides a curtain assembly, comprising:
a curtain fabric having a front surface, a rear surface, a top edge portion, a bottom edge portion, and two side edge portions extending between the top edge portion and the bottom edge portion;
an upper supporting shaft coupled to the top edge portion, the upper supporting shaft having a first supporting end portion and a second supporting end portion, and being suspendedly affixed to an external support;
a lower supporting shaft coupled to the bottom edge portion of the curtain fabric;
first and second coupling member having a first guiding hole and a second guiding hole respectively, the first coupling member and the second coupling member spacedly being supported above the first supporting end portion of the upper supporting shaft;
a third coupling member having a third guiding hole, and being supported above the upper supporting shaft;
a fourth coupling member having a fourth guiding hole, and being supported above the upper supporting shaft at a position spaced apart from the third coupling member;
a connecting cord sequentially extending between the first coupling member and the second coupling member to form a handle loop, the connecting cord passing through the first guiding hole extending to pass through the third guiding hole and extend around the curtain fabric from the front surface to the rear surface and connect with an external support,
the connecting cord passing through the second guiding hole being arranged to pass through the fourth guiding hole and extend around the curtain fabric from the front surface to the rear surface thereof and connect with an external support;
the curtain assembly being operated between a shading position and a retracted position, wherein in the shading position, the curtain fabric is fully extended between the upper supporting shaft and the lower supporting shaft, wherein in the retracted position, the handle loop is pulled and retained to pull the lower supporting shaft and roll the curtain fabric toward the upper supporting shaft so as to allow the curtain fabric to be retracted and form a roll.

In another aspect of the present invention, it provides a method of assembling a curtain assembly, comprising the steps of:
(a) detachably affixing an upper supporting shaft and a lower supporting shaft to a top edge portion and a bottom edge portion of a curtain fabric respectively;
(b) detachably affixing a first coupling member, a second coupling member, a third coupling member and a fourth coupling member on an external object the first coupling member having a first guiding hole, the second coupling member having a second guiding hole, the third coupling member having a third guiding hole, and the fourth coupling member having a fourth guiding hole;
(c) extending a connecting cord through the first coupling member and the second coupling member to form a handle loop;
(d) extending a first section of the connecting cord from the first coupling hole along the top edge portion of the curtain fabric to pass through the third coupling hole of the third coupling member, and further passing around the curtain fabric and finally affixing to an external object; and
(e) extending a second section of the connecting cord from the second coupling hole along the top edge portion of the curtain fabric to pass through the fourth coupling hole of the fourth coupling member, and further passing around the curtain fabric and finally affixing to an external object.

This summary presented above is provided merely to introduce certain concepts and not to identify any key or essential features of the claimed subject matter.

### BRIEF DESCRIPTION OF THE DRAWINGS

FIG. 1 is a perspective view of a curtain assembly according to a first preferred embodiment of the present invention.

FIG. 2 is a perspective view of an upper supporting shaft of the curtain assembly according to the first preferred embodiment of the present invention.

FIG. 3 is a perspective view of a lower supporting shaft of the curtain assembly according to the first preferred embodiment of the present invention.

FIG. 4 is perspective view of a curtain assembly according to the first preferred embodiment of the present invention, illustrating that the curtain assembly is in the retracted position.

FIG. 5 is a block diagram illustrating a method of assembling a curtain assembly according to the first preferred embodiment of the present invention.

FIG. 6 is a first alternative mode of the curtain assembly according to the first preferred embodiment of the present invention.

FIG. 7 is perspective view of a curtain assembly according to the first alternative mode of the present invention, illustrating that the curtain assembly is in the retracted position.

FIG. 8 is a second alternative mode of the curtain assembly according to the first preferred embodiment of the present invention.

FIG. 9 is a perspective view of an upper supporting shaft of the curtain assembly according to the second alternative mode of the first preferred embodiment of the present invention.

FIG. 10 another perspective view of the upper supporting shaft of the curtain assembly according to the second alternative mode of the first preferred embodiment of the present invention, illustrating the number of holes may be varied.

FIG. 11 is a perspective view of an upper supporting shaft of the curtain assembly according to the second alternative mode of the first preferred embodiment of the present invention, illustrating that the curtain fabric does not contain connecting holes.

FIG. 12 is a block diagram illustrating a method of assembling a curtain assembly according to the second alternative mode of the first preferred embodiment of the present invention.

FIG. 13A is a perspective views of a curtain assembly according to a second preferred embodiment of the present invention, illustrating that the curtain assembly is in the shading position.

FIG. 13B is a partial enlarged perspective view of FIG. 13A, illustrating an upper supporting shaft of the curtain assembly.

FIG. 13C is another partial enlarged perspective view of FIG. 13A, illustrating a lower supporting shaft of the curtain assembly.

FIG. 14 is a perspective view of a curtain assembly according to the second preferred embodiment of the present invention, illustrating that the curtain assembly is in the retracted position.

FIG. 15 is a schematic diagram of the certain assembly according to the second preferred embodiment of the present invention.

FIG. 16 is a schematic diagram illustrating an extension path of a connecting cord of the certain assembly according to the second preferred embodiment of the present invention.

FIG. 17 is a perspective view of a first coupling member and a second coupling member of the curtain assembly according to the second preferred embodiment of the present invention.

FIG. 18 is a perspective view of a third coupling member of the curtain assembly according to the second preferred embodiment of the present invention.

FIG. 19 is a perspective view of a fourth coupling member of the curtain assembly according to the second preferred embodiment of the present invention.

FIG. 20A to FIG. 20D perspective views of first through fourth coupling member of the curtain assembly according to the second preferred embodiment of the present invention respectively.

FIG. 21 is a schematic diagram illustrating an extension path of a connecting cord according to the second preferred embodiment of the present invention.

FIG. 22 is an alternative mode of the curtain assembly according to the second preferred embodiment of the present invention.

FIG. 23 is another perspective view according to the alternative mode of the curtain assembly according to the second preferred embodiment of the present invention.

FIG. 24 is a block diagram illustrating a method of assembling a curtain assembly according to the second preferred embodiment of the present invention respectively.

FIG. 25 is a block diagram illustrating a method of assembling a curtain assembly according to the alternative mode of the second preferred embodiment of the present invention respectively.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

In the following descriptions, it should also be appreciated that the terms “arrange” and “set” in the following description refer to the connecting relationship in the accompanying drawings for easy understanding of the present invention. For example, the “arrange” and “set” may refer to one element directly or indirectly set or arrange on another element. Therefore, the above terms should not be an actual connection limitation of the elements of the present invention.

It should also be appreciated that the terms “center”, “length”, “width”, “thickness”, “top”, “bottom”, “front”, “rear”, “left”, “right”, vertical”, “horizontal”, “upper”, “lower”, “interior”, and “exterior” in the following description refer to the orientation or positioning relationship in the accompanying drawings for easy understanding of the present invention without limiting the actual location or orientation of the present invention. Therefore, the above terms should not be an actual location limitation of the elements of the present invention.

Moreover, it should be appreciated that the terms “first”, “second”, “one”, “a”, and “an” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of the present invention.

It should be appreciated that the terms “install”, “connect”, “couple”, and “mount” in the following description refer to the connecting relationship in the accompanying drawings for easy understanding of the present invention. For example, the connection may refer to permanent connection or detachable connection. Therefore, the above terms should not be an actual connection limitation of the elements of the present invention.

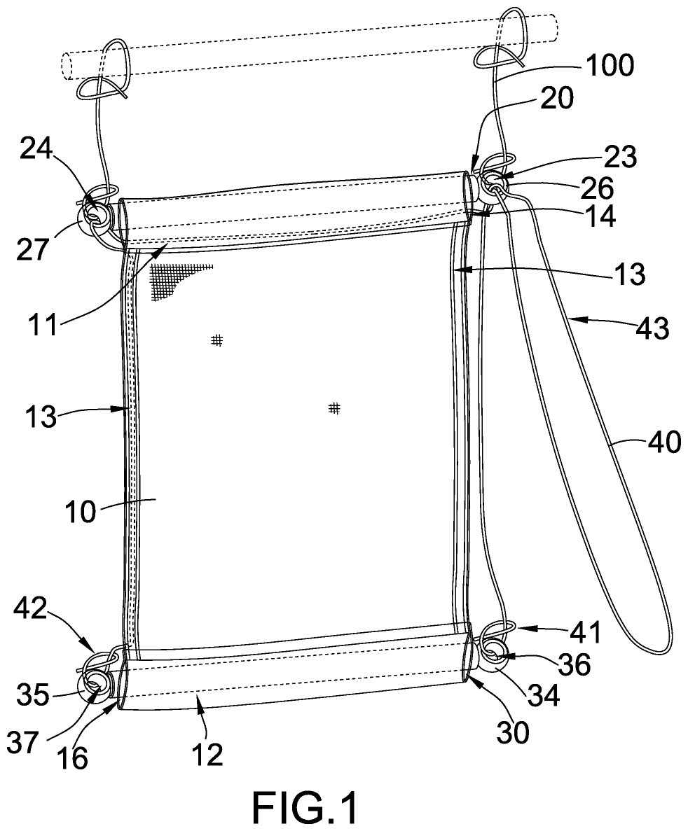

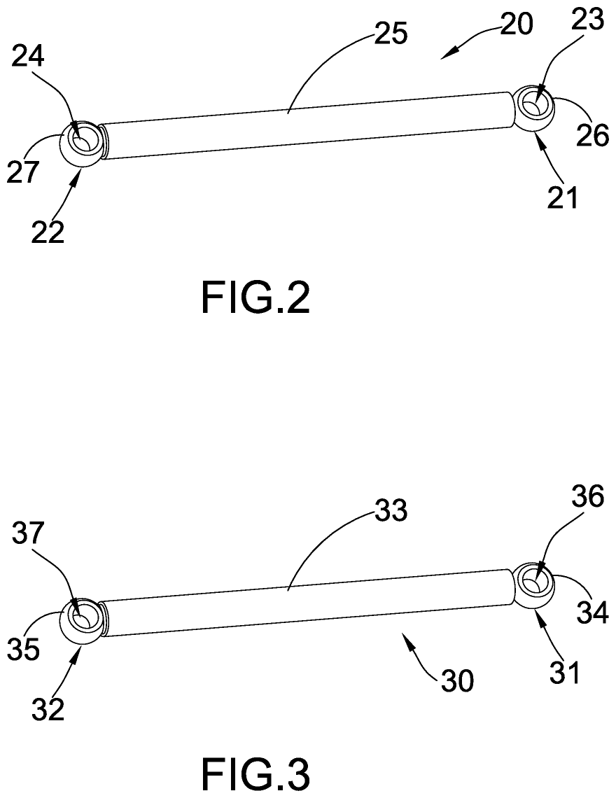

Referring to FIG. 1 to FIG. 3 of the drawings, a curtain assembly according to a first preferred embodiment of the present invention is illustrated. Broadly, the curtain assembly may comprise a curtain fabric 10, an upper supporting shaft 20, a lower supporting shaft 30, and a connecting cord 40.

The curtain fabric 10 may have a top edge portion 11, a bottom edge portion 12, and two side edge portions 13 extending between the top edge portion 11 and the bottom edge portion 12.

The upper supporting shaft 20 may be detachably coupled to the top edge portion 11 of the curtain fabric 10. The upper supporting shaft 20 may have a first supporting end portion 21, a second supporting end portion 22, a first coupling hole 23 and a second coupling hole 24 formed on the first supporting end portion 21 and the second supporting end portion 22 respectively.

The lower supporting shaft 30 may be coupled to the bottom edge portion 12 of the curtain fabric 10. The lower supporting shaft 30 may have a third supporting end portion 31 and a fourth supporting end portion 32.

The connecting cord 40 may have a first connecting end portion 41 affixed to the third supporting end portion 31 of the lower supporting shaft 30, and a second connecting end portion 42 affixed to the fourth supporting end portion 32 of the lower supporting shaft 30. The connecting cord 40 may sequentially extend from the third supporting end portion 31 along the corresponding side edge portion 13 of the curtain fabric 10 and repetitively pass through the first coupling hole 23 to form a handle loop 43, the connecting cord 40 passing through the first coupling hole 23 may further extend along the top edge portion 11 of the curtain fabric 10 and pass through the second coupling hole 24, the connecting cord 40 passing through the second coupling hole 24 may further extend along the corresponding side edge portion 13 of the curtain fabric 10 and may be affixed on the fourth supporting end portion 32 of the lower supporting shaft 30.

The curtain assembly of the present invention may be operated between a shading position and a retracted position, wherein in the shading position, the curtain fabric 10 is fully extended between the upper supporting shaft 20 and the lower supporting shaft 30, wherein in the retracted position, the handle loop 43 may be pulled and retained to pull the lower supporting shaft 30 toward the upper supporting shaft 20 so as to allow the curtain fabric 10 to be retracted.

According to the first preferred embodiment of the present invention, the curtain fabric 10 may be configured from textile or plastic material so that it may be utilized to block sunlight and provide shade. Additionally, the curtain fabric 10 may have a certain waterproof ability so that it may also be utilized to block a certain amount of water.

In this first preferred embodiment of the present invention, the curtain fabric 10 may have a rectangular cross-sectional shape when viewed from the front and may have an upper elongated slot 14 extending along the top edge portion 11 so that the upper supporting shaft 20 and the corresponding portion of the connecting cord 40 may pass through the upper elongated slot 14.

The curtain fabric 10 may further have a lower elongated slot 16 extending along the bottom edge portion 12 so that the lower supporting shaft 30 may pass through the lower elongated slot 16. One skilled in the art may appreciate that the upper elongated slot 14 and the lower elongated slot 16 may be optionally provided on the curtain fabric 10. When the curtain fabric 10 does not have the upper elongated slot 14 and the lower elongated slot 16, the upper supporting shaft 20 and the lower supporting shaft 30 may simply extend along the upper edge portion 11 and the bottom edge portion 12 of the curtain fabric at a rear side or a front side thereof. In this first preferred embodiment, the curtain fabric 10 may have both the upper elongated slot 14 and the lower elongated slot 16 extending along the upper edge portion 11 and the bottom edge portion 12 respectively.

Referring to FIG. 1 of the drawings, the upper supporting shaft 20 may extend through the upper elongated slot 14 and may be suspendedly supported by at least one mounting cable 100. Thus, the mounting cable 100 may detachably fasten the upper supporting shaft 20 to an external object, such as an external bar, so as to secure the curtain assembly to that external object.

According to the first preferred embodiment of the present invention, the upper supporting shaft 20 may comprise a first main shaft body 25, a first annular member 26 and a second annular member 27 detachably attached on two ends of the first main shaft body 25 respectively, wherein the first supporting end portion 21 and the second supporting end portion 22 are formed on the first annular member 26 and a second annular member 27 respectively. Thus, the first coupling hole 23 and the second coupling hole 24 may be formed on the first annular member 26 and a second annular member 27 respectively.

It is worth mentioning that the above-mentioned structure of the upper supporting shaft 20 may represent a particular configuration of the present invention. One skilled in the art may contemplate several alternatives of the upper supporting shaft 20. For example, the upper supporting shaft 20 may have a single first main shaft body 25 without the first annular member 26 and the second annular member 27, wherein the first supporting end portion 21 and the second supporting end portion 22 are formed as two ends portion thereof. As such, the first coupling hole 23 and the second coupling hole 24 may be directly formed on the first main shaft body 25 at two end portions thereof.

The first annular member 26 may be configured to have a ring-shape structure and may be detachably attached on one end of the first main shaft body 25. Similarly, the second annular member 27 may also be configured to have a ring-shape structure and may be detachably attached on another end of the first main shaft body 25. Thus, the first annular member 26 and the second annular member 27 may be opposite to each other. The connecting cord 40 may pass through the first annular member 26 and the second annular member 27 in the manner described above for lifting and releasing the curtain fabric 10. The first main shaft body 25, the first annular member 26 and the second annular member 27 may be configured from metallic material so as to offer strong structural integrity to support the curtain fabric 10.

As a slight alternative, the first main shaft body 25, the first annular member 26 and the second annular member 27 may form an integral structure so that the first annular member 26 and the second annular member 27 may not be detached from the first main shaft body 25.

The connecting cord 40 may have configured as a deformable, flexible and elongated cable or string and may be manufactured to withstand a predetermined amount of weight (at least the overall weight of the curtain assembly). The connecting cord 40 may be made from metallic or non-metallic material.

Referring to FIG. 1 and FIG. 3 of the drawings, the lower supporting shaft 30 may comprise a second main shaft body 33, a third annular member 34 and a fourth annular member 35 detachably attached on two ends of the second main shaft body 33 respectively, wherein the third supporting end portion 31 and the fourth supporting end portion 32 are formed on the third annular member 34 and a fourth annular member 35 respectively. The lower supporting shaft 30 may further have a third coupling hole 36 and the fourth coupling hole 37 formed on the third annular member 34 and the fourth annular member 35 respectively.

In this first preferred embodiment, the first connecting end portion 41 and the second connecting end portion 42 may be detachably affixed to the third annular member 34 and the fourth annular member 35 respectively. One skilled in the art may also appreciate that the first connecting end portion 41 and the second connecting end portion 42 may also be affixed to any suitable positions on the lower supporting shaft 30.

It is worth mentioning that the above-mentioned structure of the lower supporting shaft 30 may also have several alternatives as in the case of the upper supporting shaft 20. For example, the lower supporting shaft 30 may have a single second main shaft body 33 without the third annular member 34 and the fourth annular member 35, wherein the third supporting end portion 31 and the fourth supporting end portion 32 are formed as two ends portion thereof. As such, the third coupling hole 36 and the fourth coupling hole 37 may be directly formed on the second main shaft body 33 at two end portions thereof.

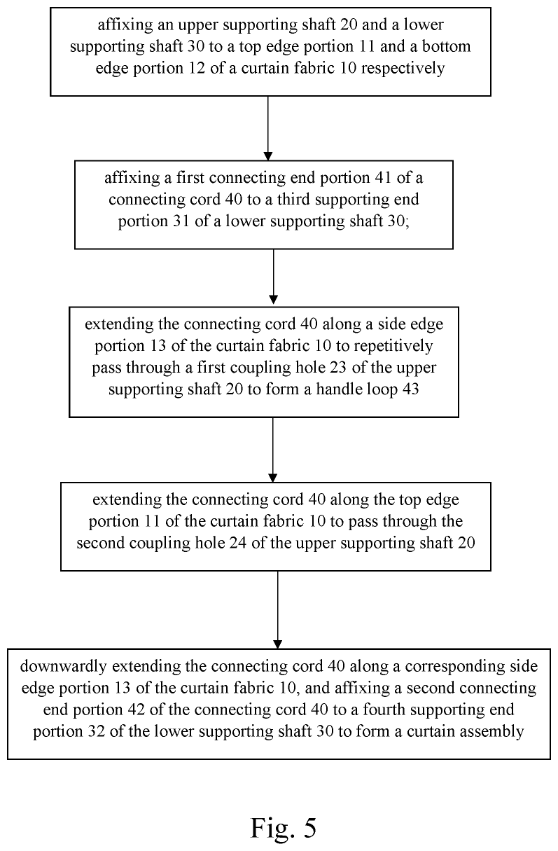

Referring to FIG. 5 of the drawings, the present invention may also provide a method of manufacturing or assembling a curtain assembly, comprising the steps of:
(a) detachably affixing an upper supporting shaft 20 and a lower supporting shaft to a top edge portion 11 and a bottom edge portion 12 of a curtain fabric 10 respectively;
(b) detachably affixing a first connecting end portion 41 of a connecting cord 40 to a third supporting end portion 31 of a lower supporting shaft 30;
(c) extending the connecting cord 40 along a side edge portion 13 of the curtain fabric 10 to repetitively pass through a first coupling hole 23 of the upper supporting shaft to form a handle loop 43;
(d) extending the connecting cord 40 along the top edge portion 11 of the curtain fabric 10 to pass through the second coupling hole 24 of the upper supporting shaft 20; and
(e) downwardly extending the connecting cord 40 along a corresponding side edge portion 13 of the curtain fabric 10, and affixing a second connecting end portion 42 of the connecting cord 40 to a fourth supporting end portion 32 of the lower supporting shaft 30 to form the curtain assembly.

In step (a), the upper supporting shaft 20 and the lower supporting shaft 30 may be inserted and extend along the upper elongated slot 14 and the lower elongated slot 16 of the curtain fabric 10 respectively so as to detachably affix the upper supporting shaft 20 and the lower supporting shaft 30 to the top edge portion 11 and the bottom edge portion 12 of the curtain fabric 10 respectively.

In step (c), the connecting cord 40 may pass through the first coupling hole 23 twice and form a handle loop underneath the first coupling hole 23. The handle loop 43 may be utilized for allowing a user to operate the curtain assembly (described below), and to secure the curtain assembly to an external object. The connecting cord 40 may upwardly extend from the first connecting end portion 41 along the corresponding side edge portion 13 of the curtain fabric and pass through the first coupling hole 23. The connecting cord may then downwardly extend from the first coupling hole 23 to a certain extent and go back up the first coupling hole 23 to form the handle loop 43 at a position underneath the upper supporting shaft 20.

Specifically in this first preferred embodiment, the first connecting end portion 41 may be arranged to pass through the third coupling hole 36 and affix to the third annular member 34, as shown in FIG. 1 of the drawings.

In step (d), the connecting cord 40 may pass through the upper elongated slot 14 and extend from one side of the curtain fabric 10 to the other side. In step (e), the connecting cord 40 passing through the upper elongated slot 14 may further extend downwardly along the side edge portion 13 of the curtain fabric 10 and may be affixed to the fourth supporting end portion 32 of the lower supporting shaft 30. In this first preferred embodiment, the second connecting end portion 42 may be arranged to pass through the fourth coupling hole 37 and affixed to the fourth annular member 32.

The operation of the present invention is as follows: the curtain assembly of the present invention may be operated between a shading position and a retracted position, wherein in the shading position, the curtain fabric 10 is fully extended between the upper supporting shaft 20 and the lower supporting shaft 30. The curtain fabric 10, due to its own weight, may fully extend and provide shading to an indoor or outdoor space.

On the other hand, when the curtain assembly is in the retracted position, the handle loop 43 may be detached from the external object and pulled by the user so that the lower supporting shaft 30 may be pulled upwardly toward the upper supporting shaft 20. As result, the curtain fabric 10 may be rolled or folded by the lower supporting shaft 30 so as to expose certain originally shaded area to sunlight. A user may then affix the handle loop 43 to an external object so as to retain the certain assembly in the retracted position.

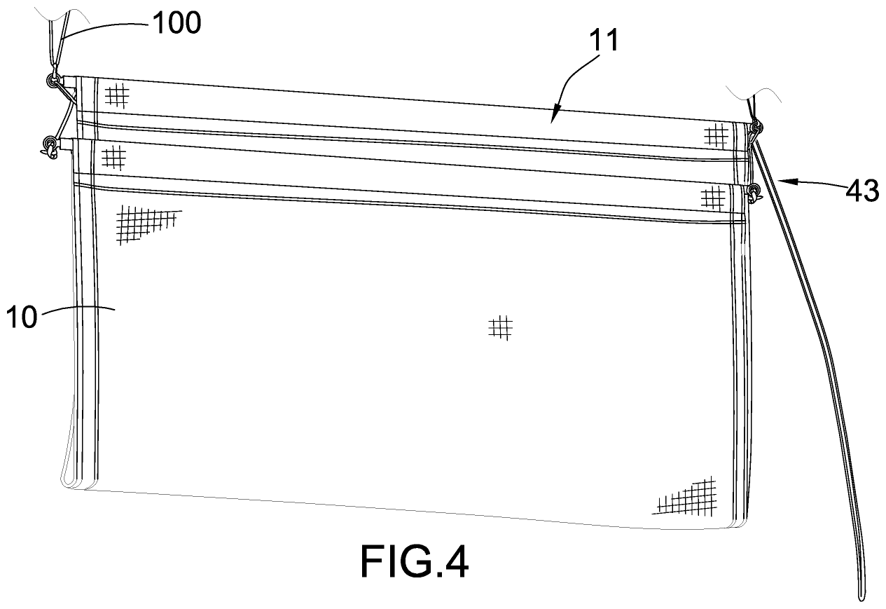

One skilled in the art may appreciate that by adjusting the extent to which the handle loop 43 is pulled, the user of the present invention may manually adjust the extent to which the curtain fabric 10 is retracted. In other words, a user may selectively adjust the retraction of the curtain fabric 10 he or she may need due to a given circumstance, as shown in FIG. 4 of the drawings.

From the forgoing descriptions, it can be shown that the curtain assembly of the present invention is very easy to assemble without involving the use of any pulley. A user may easily set up the curtain assembly of the present invention in indoor or outdoor environment. After use, the user may also easily detach the curtain assembly (by unfastening the mounting cable 100) from the external object. All the components of the curtain assembly may be conveniently and compactly transported by a regular vehicle.

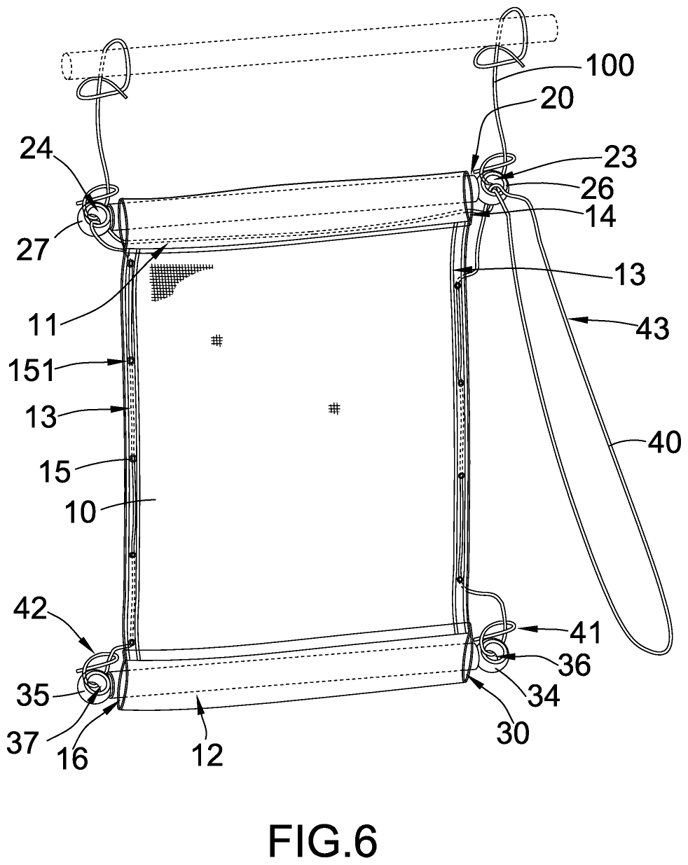

Referring to FIG. 6 of the drawings, a first alternative mode of the curtain fabric according to the first preferred embodiment of the present invention is illustrated. The curtain assembly in the first alternative mode is structurally identical to that disclosed in the first preferred embodiment, except that the curtain fabric 10 may further have a plurality of connecting holes 15 formed on the side edge portions 13 of the curtain fabric 10. A corresponding portion of the connecting cord 40 may pass through one of more of the connecting holes 15 so as to connect with the curtain fabric 10. Moreover, each of the connecting holes 15 may be reinforced by a metallic ring 151.

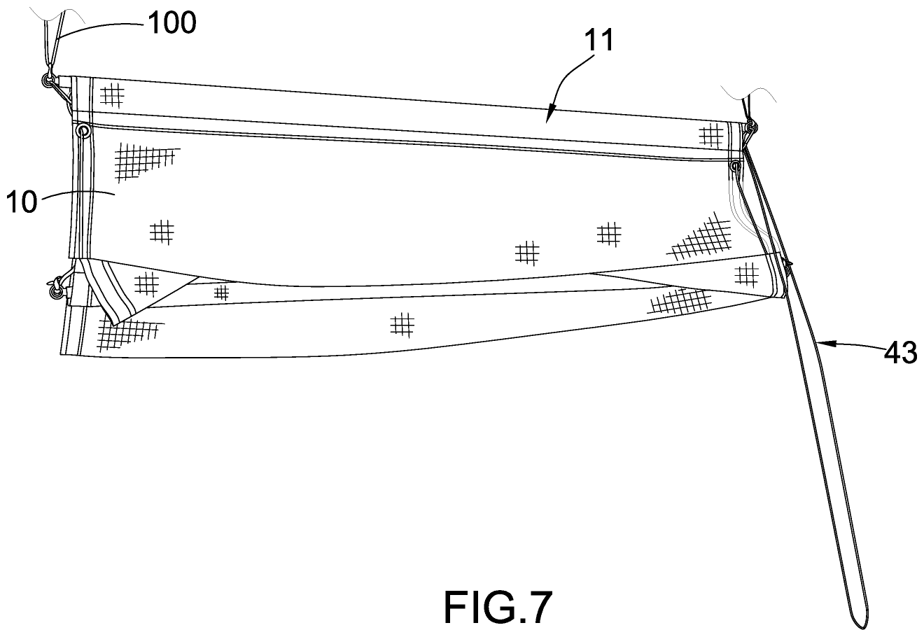

It is worth mentioning that since the connecting cord 40 may be arranged to pass through the connecting holes 15 while it extends along the corresponding side edge portion 13 of the curtain fabric 10, the curtain fabric 10 may be substantially retracted, as shown in FIG. 7 of the drawings.

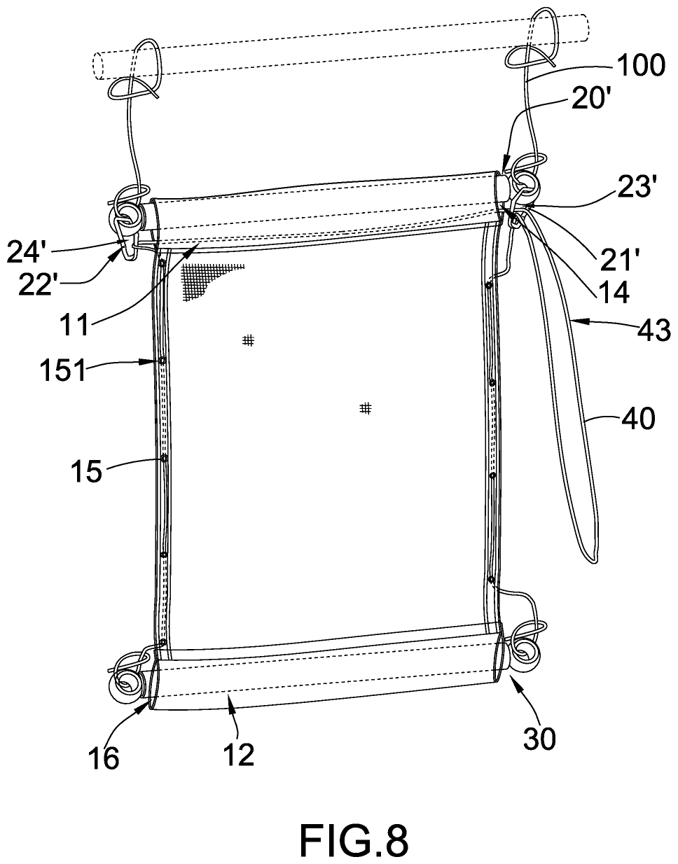

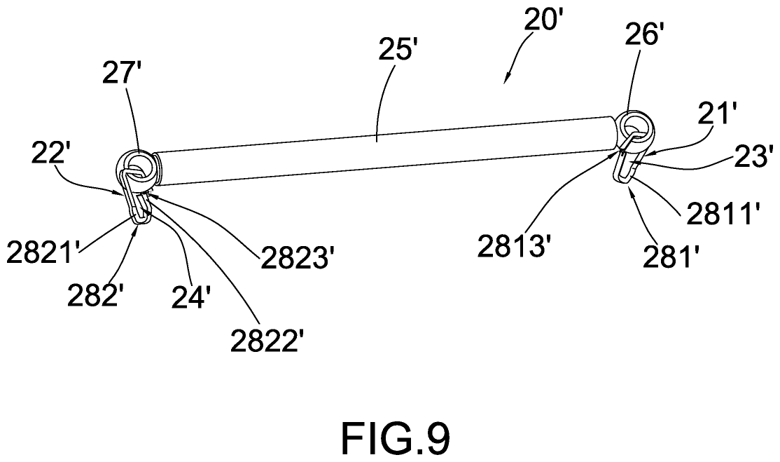

Referring to FIG. 8 to FIG. 10 of the drawings, a second alternative mode of the curtain fabric according to the first preferred embodiment of the present invention is illustrated. The second alternative mode is very similar to the first preferred embodiment described above, except the upper supporting shaft 20′. In addition, the manner in which the connecting cord 40 is attached on the curtain fabric 10 is also different from the first preferred embodiment described above. Other components are structurally identical to what have been disclosed in the first preferred embodiment above.

Thus, according to the second alternative mode, the curtain assembly may comprise the curtain fabric 10, an upper supporting shaft 20′, the bottom supporting shaft 30, and the connecting cord 40.

The upper supporting shaft 20′ may be coupled to the top edge portion 11. The upper supporting shaft 20′ may have a first supporting end portion 21′, a second supporting end portion 22′, a first coupling hole 23′ and a second coupling hole 24′ formed on the first supporting end portion 21′ and the second supporting end portion 22′ respectively.

Specifically, the upper supporting shaft 20′ may comprise a first main shaft body 25′, a first annular member 26′, a second annular member 27′ detachably attached on two ends of the first main shaft body 25′ respectively, a first extender ring 281′ and a second extender ring 282′ detachably attached on the first annular member 26′ and the second annular member 27′ respectively. The first coupling hole 23′ and the second coupling hole 24′ may be formed in the first extender ring 281′ and the second extender ring 282′ respectively. The purpose of the first extender ring 281′ and the second extender ring 282′ is to enhance a smoothness of the movement of the connecting cord 40 so as to enhance the smoothness of the retracting motion of the curtain fabric 10.

Thus, the first extender ring 281′ and the second extender ring 282′ may constitute the first supporting end portion 21′ and the second supporting end portion 22′ of the upper supporting shaft 20′, while the first coupling hole 23′ and the second coupling hole 24′ may be formed in the first extender ring 281′ and the second extender ring 282′ respectively.

The connecting cord 40 may have a first connecting end portion 41 affixed to the third supporting end portion 31 of the lower supporting shaft 30, and a second connecting end portion affixed to the fourth supporting end portion 32 of the lower supporting shaft 30. The connecting cord 40 may sequentially extend from the third supporting end portion 31 along the corresponding side edge portion 13 of the curtain fabric 10 and repetitively pass through the first coupling hole 23′ to form a handle loop 43, the connecting cord passing through the first coupling hole 23′ may further extend along the top edge portion 11 of the curtain fabric 10 and pass through the second coupling hole 24′, the connecting cord 40 passing through the second coupling hole 24′ may further extend along the corresponding side edge portion 13 of the curtain fabric 10 and may be affixed on the lower supporting shaft 30.

Again, the curtain assembly may be operated between a shading position and a retracted position, wherein in the shading position, the curtain fabric 10 may be fully extended between the upper supporting shaft 20 and the lower supporting shaft 30, wherein in the retracted position, the handle loop 43 may be pulled and retained to pull the lower supporting shaft 30 toward the upper supporting shaft 20 so as to allow the curtain fabric to be retracted.

According to the second alternative mode of the present invention, the curtain fabric 10 may have a rectangular cross sectional shape when viewed from the front and may have the upper elongated slot 14 extending along the top edge portion 11 so that the upper supporting shaft 20 and the corresponding portion of the connecting cord 40 may pass through the upper elongated slot 14. The curtain fabric 10 may further have the plurality of connecting holes 15 formed on the side edge portions 13 of the curtain fabric 10. A corresponding portion of the connecting cord 40 may pass through one of more of the connecting holes 15 so as to connect with the curtain fabric 10. Each of the connecting holes 15 may be reinforced by a metallic ring 151.

Moreover, the curtain fabric 10 may also have the lower elongated slot 16 extending along the bottom edge portion 12 so that the lower supporting shaft 30 may pass through the lower elongated slot 14. One skilled in the art may appreciate that the upper elongated slot 14 and the lower elongated slot 16 may be optionally provided in the curtain fabric 10.

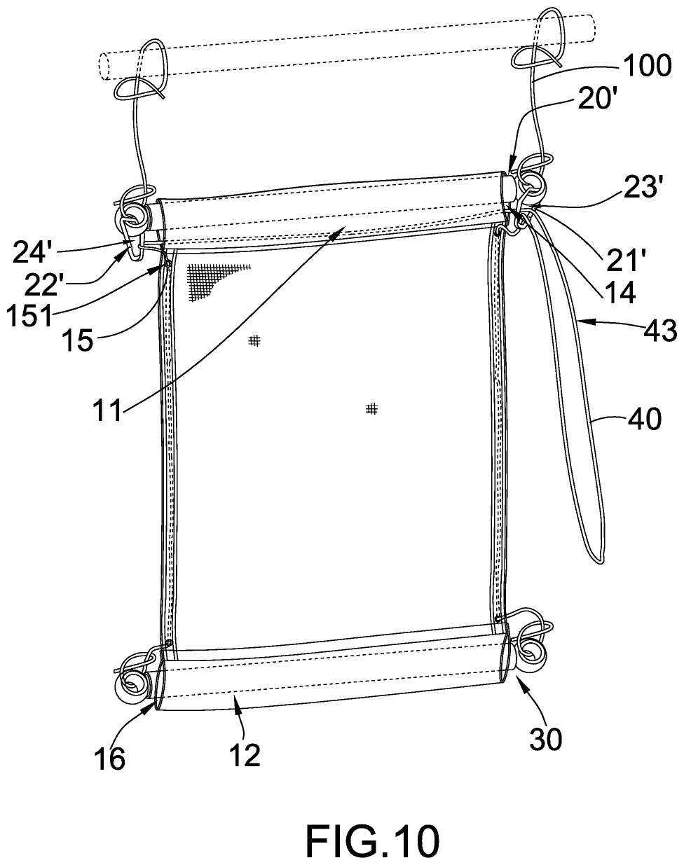

The number of connecting holes 15 may be varied according to the circumstances in which the present invention is utilized. For example, as shown in FIG. 8 of the drawings, several connecting holes 15 may be formed on along each of the side edge portions 13 of the curtain fabric 10. Alternatively, as shown in FIG. 10 of the drawings, each of the side edge portions 13 may only have two connecting holes 15 formed near the top edge portion 11 and the bottom edge portion 12 respectively. The connecting cord 40 may pass through the connecting holes 15 near the top edge portion 11 and extend along the side edge portions 13 on a rear side of the curtain fabric 10.

The first extender ring 281′ may detachably connect to the first annular member 26′. Specifically, the first extender ring 281′ may comprise a first main frame 2811′ and a first pin member 2812′ pivotally connected to the main frame 2811′. The first main frame 2811′ may be bent to form a first loop having a first opening 2813′, wherein the first pin member 2812′ may be pivotally connected to the first main frame 2811′ to selectively close and open the first opening 2813′. A first resilient member may be connected to the first main frame 2811′ to bias against the first pin member 2812′ so as to normally close the first opening 2813′ and the loop. Note that the first coupling hole 23′ may be formed as the through opening within the first extender ring 281′ (i.e. the space surrounded by the loop and the first pin member 2812′).

Similarly, the second extender ring 282′ may detachably connect to the second annular member 27′. Specifically, the second extender ring 282′ may comprise a second main frame 2821′ and a second pin member 2822′ pivotally connected to the main frame 2821′. The second main frame 2821′ may be bent to form a loop having a second opening 2823′, wherein the second pin member 2822′ may be pivotally connected to the second main frame 2821′ to selectively close and open the second opening 2823′. A second resilient member may be connected to the second main frame 2821′ to bias against the second pin member 2822′ so as to normally close the second opening 2823′ and the loop. Note that the second coupling hole 24′ may be formed as the through opening within the second extender ring 282′ (i.e. the space surrounded by the second loop and the second pin member 2822′)

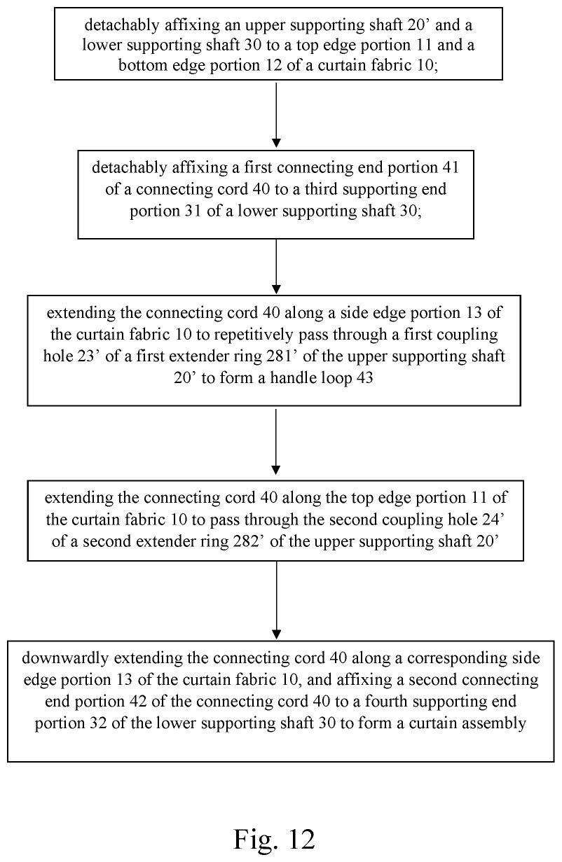

As shown in FIG. 12 of the drawings, the present invention also provides a method of manufacturing or assembling a curtain assembly, comprising the steps of:
(1) detachably affixing an upper supporting shaft 20′ and a lower supporting shaft to a top edge portion 11 and a bottom edge portion 12 of a curtain fabric 10 respectively;
(2) detachably affixing a first connecting end portion 41 of a connecting cord 40 to a third supporting end portion 31 of a lower supporting shaft 30;
(3) extending the connecting cord 40 along a side edge portion 13 of the curtain fabric 10 to repetitively pass through a first coupling hole 23′ of the upper supporting shaft 20′ to form a handle loop 43, wherein the first coupling hole 23′ may be formed in a first extender ring 281′ of the upper supporting shaft 20′;
(4) extending the connecting cord 40 along the top edge portion 11 of the curtain fabric 10 to pass through the second coupling hole 24′ of the upper supporting shaft 20′, wherein the second coupling hole 24′ may be formed in a second extender ring 282′ of the upper supporting shaft 20′; and
(5) downwardly extending the connecting cord 40 along a corresponding side edge portion 13 of the curtain fabric 10, and affixing a second connecting end portion 42 of the connecting cord 40 to a fourth supporting end portion 32 of the lower supporting shaft 30 to form the curtain assembly.

In step (3) and step (4) above, the connecting cord 40 may be arranged to pass through the connecting holes 15 while it extends along the corresponding side edge portion 13 of the curtain fabric 10. This arrangement allows the entire curtain fabric 10 to be retracted when the handle loop is pulled by the user of the present invention.

The operation of the present invention is as follows: the curtain assembly of the present invention may be operated between a shading position and a retracted position, wherein in the shading position, the curtain fabric 10 is fully extended between the upper supporting shaft 20′ and the lower supporting shaft 30. The curtain fabric 10, due to its own weight, may fully extend and provide shading to an indoor or outdoor space.

On the other hand, when the curtain assembly is in the retracted position, the handle loop 43 may be detached from the external object and pulled by the user so that the lower supporting shaft 30 may be pulled upwardly toward the upper supporting shaft 20′. As result, the curtain fabric 10 may be rolled or folded by the lower supporting shaft 30 so as to expose certain originally shaded area to sunlight. A user may then affix the handle loop 43 to an external object so as to retain the certain assembly in the retracted position.

It is worth mentioning that since the connecting cord 40 may be arranged to pass through the connecting holes 15 while it extends along the corresponding side edge portion 13 of the curtain fabric 10, the curtain fabric 10 may be substantially retracted in such a manner that the curtain fabric may be repetitively folded to expose more sunlight to a designated area.

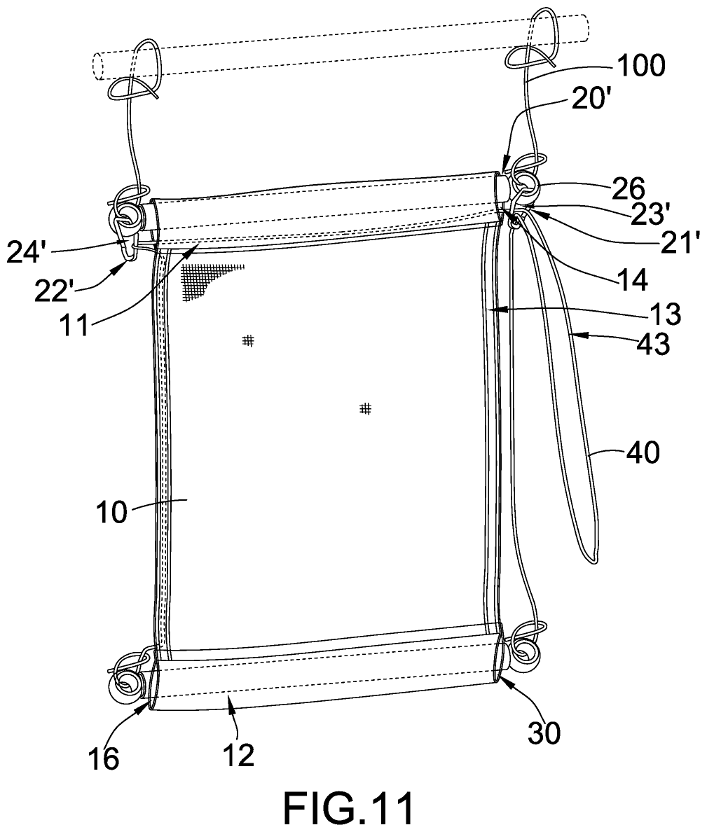

On skilled in the art may also appreciate that the curtain fabric 10 may not have the connecting holes 15, and in this situation, the connecting cord 40 may simply extend along the side edge portions 13 of the curtain fabric 10 at a rear or a front side thereof, as shown in FIG. 11 of the drawings.

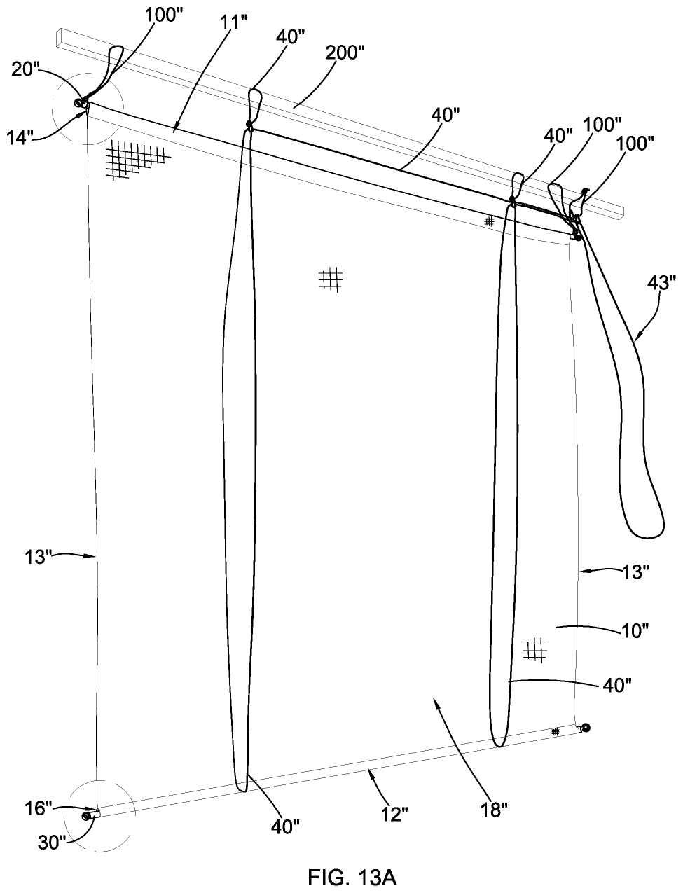

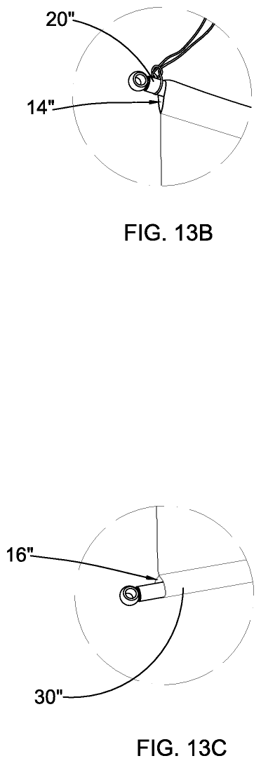

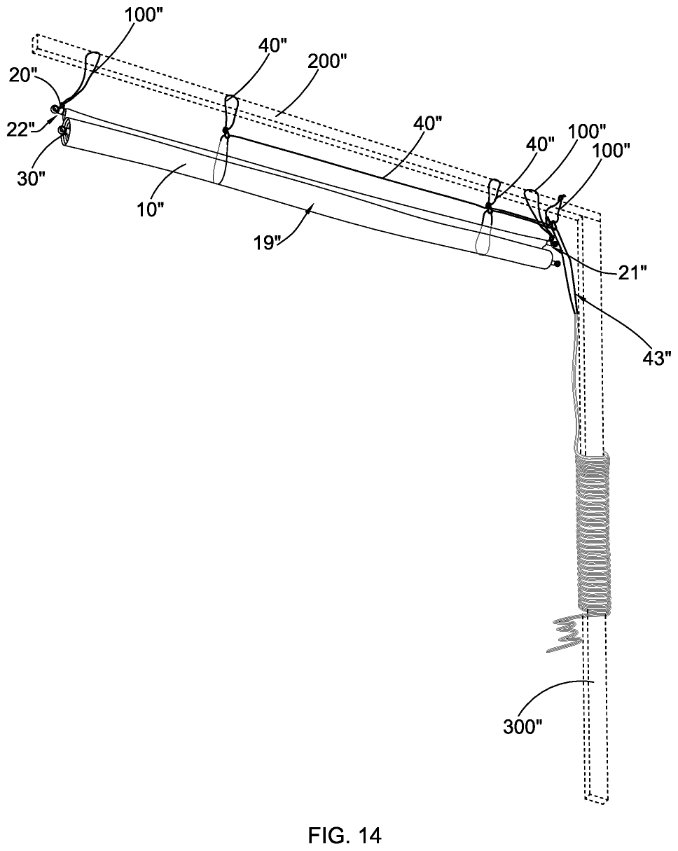

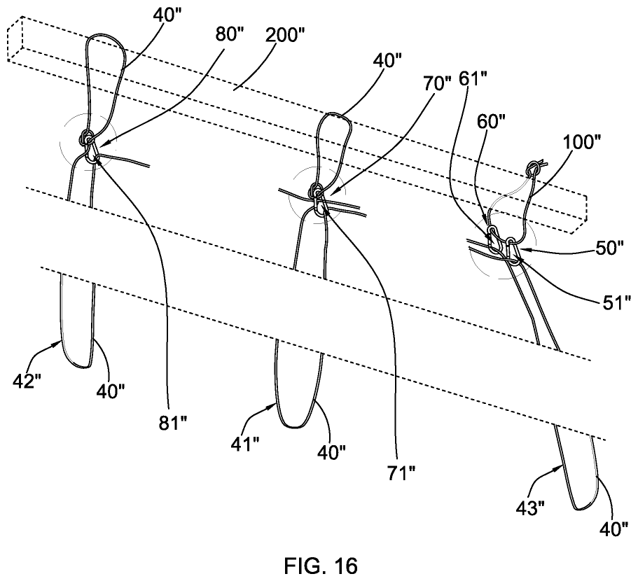

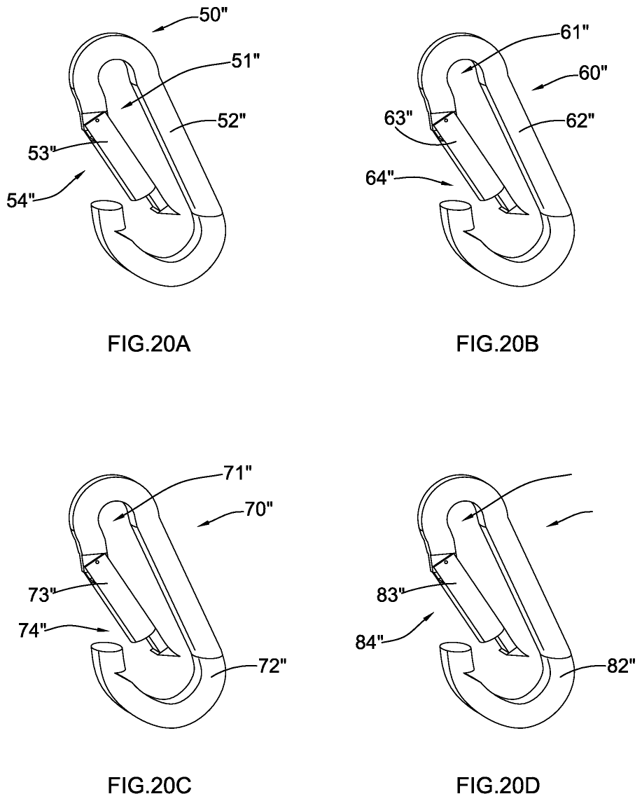

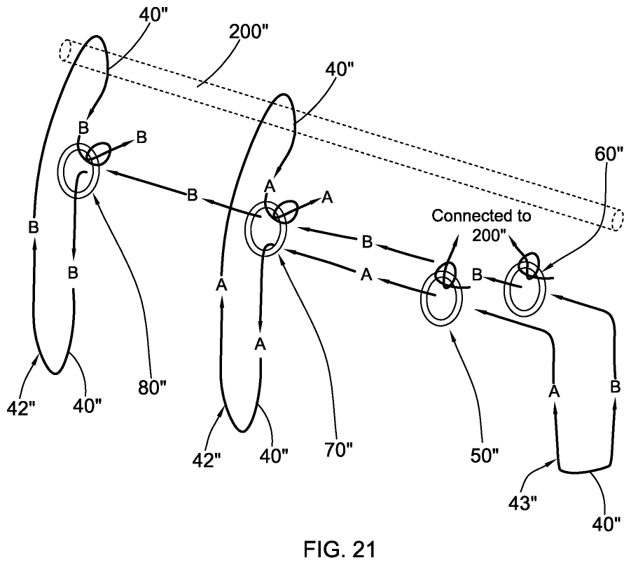

Referring to FIG. 13A to FIG. 13C, FIG. 14 to FIG. 19, FIG. 20A to FIG. 20D and FIG. 21 of the drawings, a curtain assembly according to a second preferred embodiment of the present invention is illustrated. The curtain assembly in this second preferred embodiment may allow the curtain fabric 10″ to be retracted and rolled to a compact size when the curtain assembly is in the retracted position. In order to accomplish this objective, the connecting cord 40″ may extend along the curtain fabric 10″ in a different way as described below.

In this second preferred embodiment of the present invention, the curtain assembly may comprise a curtain fabric 10″, an upper supporting shaft 20″, a lower supporting shaft 30″, a first coupling member 50″, a second coupling member 60″, a third coupling member 70″, a fourth coupling member 80, and a connecting cord 40″.

The curtain fabric 10″ may have a front surface 18″, a rear surface 19″, a top edge portion 11″, a bottom edge portion 12″, and two side edge portions 13″ extending between the top edge portion 11″ and the bottom edge portion 12″.

The upper supporting shaft 20″ may be coupled or affixed to the top edge portion 11″ of the curtain fabric 10″, and may have a first supporting end portion 21″ and a second supporting end portion 22″, and may be suspendedly affixed to an external support, such as an external horizontal bar 200″ in a patio.

The lower supporting shaft 30″ may be coupled or affixed to the bottom edge portion 12″ of the curtain fabric 10″.

The first coupling member 50″ and the second coupling member 60″ may have a first guiding hole 51″ and a second guiding hole 61″ respectively, wherein the first coupling member 50″ and the second coupling member 60″ are spacedly supported above or in vicinity of the first supporting end portion 21″ of the upper supporting shaft 20″.

The third coupling member 70″ may have a third guiding hole 71″, and may be supported above or in vicinity of the upper supporting shaft 20″.

The fourth coupling member 80″ may have a fourth guiding hole 81″, and may be supported above or in vicinity of the upper supporting shaft 20″ at a position spaced apart from the third coupling member 70″.

The connecting cord 40″ may sequentially extend between the first coupling member 50″ and the second coupling member 60″ to form a handle loop 43″. The connecting cord 40″ passing through the first coupling hole 51″ may extend to pass through the third guiding hole 71″ of the third coupling member 70″ and extend around the curtain fabric 10″ from the front surface 18″ to the rear surface 19″ and connect with an external support, such as a horizontal bar 200″.

The connecting cord 40″ passing through the second coupling hole 61″ of the second coupling member 60″ may be arranged to pass through the fourth guiding hole 81″ of the fourth coupling member 80″ and extend around the curtain fabric 10″ from the front surface 18″ to the rear surface 19″ and connect with an external support, such as a horizontal bar 200″.

The curtain assembly of the present invention may be operated between a shading position and a retracted position, wherein in the shading position, the curtain fabric 10″ is fully extended between the upper supporting shaft 20″ and the lower supporting shaft 30″, wherein in the retracted position, the handle loop 43″ may be pulled and retained to pull the lower supporting shaft 30″ and roll the curtain fabric 10″ toward the upper supporting shaft 20″ so as to allow the curtain fabric 10″ to be retracted and form a roll and form a compact structure.

According to the second preferred embodiment of the present invention, the curtain fabric 10″ may also have a rectangular cross-sectional shape when viewed from the front and may have an upper elongated slot 14″ extending along the top edge portion 11″ so that the upper supporting shaft 20″ may pass through the upper elongated slot 14″.

As in the first preferred embodiment, the curtain fabric 10″ may further have a lower elongated slot 16″ extending along the bottom edge portion 12″ so that the lower supporting shaft 30″ may pass through the lower elongated slot 16″. One skilled in the art may appreciate that the upper elongated slot 14″ and the lower elongated slot 16″ may be optionally provided on the curtain fabric 10″. When the curtain fabric 10″ does not have the upper elongated slot 14″ and the lower elongated slot 16″, the upper supporting shaft 20″ and the lower supporting shaft 30″ may simply be affixed and extend along the upper edge portion 11″ and the bottom edge portion 12″ of the curtain fabric at a rear side 19″ or a front side 18″ thereof. In this second preferred embodiment, the curtain fabric 10″ may have both the upper elongated slot 14″ and the lower elongated slot 16″ extending along the upper edge portion 11″ and the bottom edge portion 12″ respectively.

Referring to FIG. 13A to FIG. 13C of the drawings, the upper supporting shaft 20″ may extend through the upper elongated slot 14″ and may be suspendedly supported by at least one mounting cable 100″. Thus, the mounting cable 100″ may detachably fasten the upper supporting shaft 20″ to an external object, such as an external bar 200″, so as to secure the curtain assembly to that external object. Moreover, a length of the upper supporting shaft 20″ may be greater than that of the upper elongated slot 14″ so that the mounting cable 100″ may be fastened to the upper elongated slot 14″ at two end portions thereof which may expose out of the upper elongated slot 14″.

On the other hand, the connecting cord 40″ may be configured as a deformable, flexible and elongated cable or string and may be manufactured to withstand a predetermined amount of weight (at least the overall weight of the curtain assembly). The connecting cord 40″ may be made from metallic or non-metallic material.

Each of the first coupling member 50″ and the second coupling member 60″ may have a ring-shaped structure in which the first guiding hole 51″ and the second guiding hole 61″ may be formed in the first coupling member 50″ and the second coupling member 60″ respectively. Similarly, each of the third coupling member 70″ and the fourth coupling member 80″ may have a ring-shaped structure in which the third guiding hole 71″ and the fourth guiding hole 81″ may be formed in the first coupling member 60″ and the second coupling member 70″ respectively. In this second preferred embodiment, each of the first through fourth coupling member 50″, 60″, 70″, 80″ may be structurally identical, and may be substantially identical or similar to the extender rings 281′, 282′ mentioned in the first preferred embodiment above.

As shown in FIG. 20A of the drawings, the first coupling member 50″ may comprise a first main frame 52″ and a first pin member 53″ pivotally connected to the first main frame 52″. The first main frame 52″ may be bent to form a first loop having a first opening 54″, wherein the first pin member 53″ may be pivotally connected to the first main frame 52″ to selectively close and open the first opening 54″. A first resilient member may be connected to the first main frame 52″ to bias against the first pin member 53″ so as to normally close the first opening 54″ and the loop. The first coupling hole 51″ may be formed as the through opening within the first coupling member 50″ (i.e. the space surrounded by the loop and the first pin member 53″).

Referring to FIG. 20B of the drawings, the second coupling member 60″ may comprise a second main frame 62″ and a second pin member 63″ pivotally connected to the second main frame 62″. The second main frame 62″ may be bent to form a second loop having a second opening 64″, wherein the second pin member 63″ may be pivotally connected to the second main frame 62″ to selectively close and open the second opening 64″. A second resilient member may be connected to the second main frame 62″ to bias against the second pin member 63″ so as to normally close the second opening 64″ and the loop. The second coupling hole 61″ may be formed as the through opening within the second coupling member 60″ (i.e. the space surrounded by the loop and the second pin member 63″).

As shown in FIG. 20C of the drawings, the third coupling member 70″ may comprise a third main frame 72″ and a third pin member 73″ pivotally connected to the third main frame 72″. The third main frame 72″ may be bent to form a third loop having a third opening 74″, wherein the third pin member 73″ may be pivotally connected to the third main frame 72″ to selectively close and open the third opening 74″. A third resilient member may be connected to the third main frame 72″ to bias against the third pin member 73″ so as to normally close the third opening 74″ and the loop. The third coupling hole 71″ may be formed as the through opening within the third coupling member 70″ (i.e. the space surrounded by the loop and the third pin member 73″).

As shown in FIG. 20D of the drawings, the fourth coupling member 80″ may comprise a fourth main frame 82″ and a fourth pin member 83″ pivotally connected to the fourth main frame 82″. The fourth main frame 82″ may be bent to form a fourth loop having a fourth opening 84″, wherein the fourth pin member 83″ may be pivotally connected to the fourth main frame 82″ to selectively close and open the fourth opening 84″. A fourth resilient member may be connected to the fourth main frame 82″ to bias against the fourth pin member 83″ so as to normally close the fourth opening 84″ and the loop. The fourth coupling hole 81″ may be formed as the through opening within the fourth coupling member 80″ (i.e. the space surrounded by the loop and the fourth pin member 83″).

As shown in FIG. 13A to FIG. 13C and FIG. 14 to FIG. 16 of the drawings, the connecting cord 40″ may extend along the first through fourth coupling member 50″, 60″, 70″, 80″ and the curtain fabric 10″ to form the curtain assembly of the present invention and to facilitate the operation stated above. Specifically, a section of the connecting cord may sequentially pass through the first guiding hole 51″ and the second guiding hole 61″ to form the handle loop 43″ between the first guiding hole 51″ and the second guiding hole 61″.

The handle loop 43″ may allow a user to grab thereon and affix to an external object, such as a patio column 300″, when the curtain assembly is in the retracted position. Moreover, a user may also be allowed to pull the handle loop 43″ and move the curtain assembly from the shading position to the retracted position.

According to the second preferred embodiment, each of the first coupling member 50″ and the second coupling member 60″ may be suspendedly supported by a mounting cable 100″ or mounting fabric. The first coupling member 50″ and the second coupling member 60″ may be fastened on an external object, such as the external horizontal bar 200″ which may also be utilized to provide support for the upper supporting shaft 20″.

The section of the connecting cord 40″ which passes through the first guiding hole 51″ may go on to extend along the top edge portion 11″ of the curtain fabric 10″ to reach the third guiding hole 71″ of the third coupling member 70″. The relevant section of the connecting cord 40″ may go on to downwardly extend on the front surface 18″ of the curtain fabric 10″ and extend around the lower supporting shaft 30″ and extend upwardly along the rear surface 19″ of the curtain fabric 10″ and may eventually fastened to an external object, such as the external horizontal bar 200″. For the sake of clarity, the section of the connecting cord 40″ which passes through the first guiding hole 51″, the third guiding hole 71″, and extend along the front surface 18″ and the rear surface 19″ of the curtain fabric 10″ in the manner described just now may be referred to as the first section 41″.

It is worth mentioning that, as a slight variation, the connecting cord 40″ passing through the third guiding hole 71″ of the third coupling member 70″ may go on to downwardly extend on the rear surface 19″ of the curtain fabric 10″ and extend around the lower supporting shaft 30″ and extend upwardly along the front surface 18″ of the curtain fabric 10″ and may eventually fastened to an external object, such as the external horizontal bar 200″.

On the other hand, the section of the connecting cord 40″ which passes through the second guiding hole 61″ may go on to extend along the top edge portion 11″ of the curtain fabric 10″ to reach the fourth guiding hole 81″ of the fourth coupling member 80″. The relevant section of the connecting cord 40″ may go on to downwardly extend on the front surface 18″ of the curtain fabric 10″ and extend around the lower supporting shaft 30″ and extend upwardly along the rear surface 19″ of the curtain fabric 10″ and may eventually fastened to an external object, such as the external horizontal bar 200″. For the sake of clarity, the section of the connecting cord 40″ which passes through the second guiding hole 61″, the fourth guiding hole 81″, and extend along the front surface 18″ and the rear surface 19″ of the curtain fabric 10″ in the manner described just now may be referred to as the second section 42″.

The first section 41″ and the second section 42″ of the connecting cord 40″ may be tightened on the third coupling member 70″ and the fourth coupling member 80″ respectively. In this case, the third coupling member 70″ and the fourth coupling member 80″ may be supported on the horizontal bar 200″ by other strings or cables.

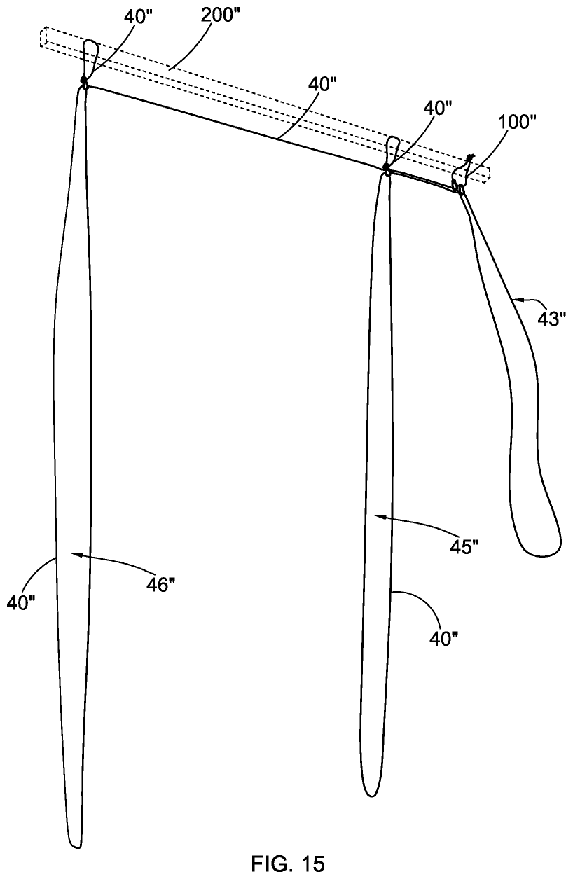

As shown in FIG. 15 of the drawings, it is worth mentioning that the first section 41″ may define a first loop 45″ and the second section may define a second loop 46″ for holding or receiving the curtain fabric 10″. When the curtain assembly is being moved to the retracted position, the curtain fabric 10″ may be guided by the first section 41″ and the second section 42″ to be rolled in the first loop 45″ and the second loop 46″. Furthermore, both the curtain fabric 10″ and the corresponding sections of the connecting cord 40″ may be retracted when the curtain assembly is moved from the shading position to the retracted position.

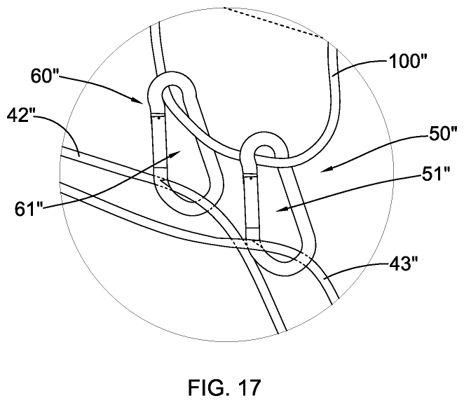

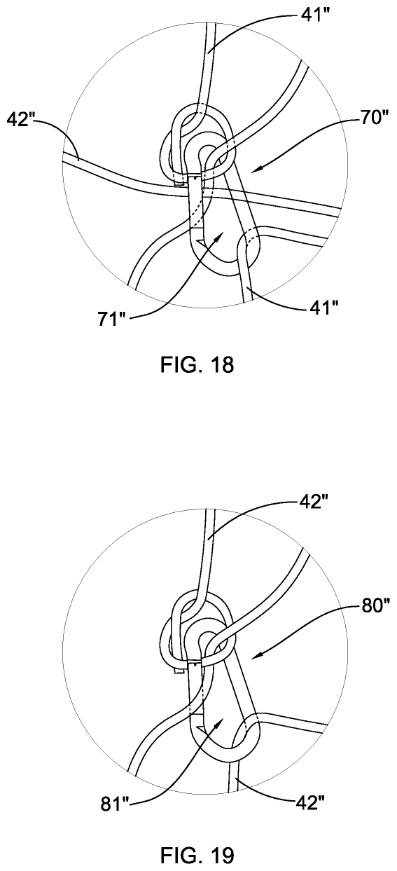

It is worth mentioning that the second section 42″ may also pass through the third guiding hole 71″ when it extends from the second guiding hole 61″ toward the fourth guiding hole 81″ (see FIG. 18). In this situation, the third coupling member 70″ may serve as an intermediate support for the second section 42″ of the connecting cord 40″. It is worth mentioning that the second section 42″ of the connecting cord 40″ does not necessarily need to pass through the third guiding hole 71″. The second section 42″ may just extend along the top edge portion 11″ of the curtain fabric 10″ without passing through the third coupling member 70″.

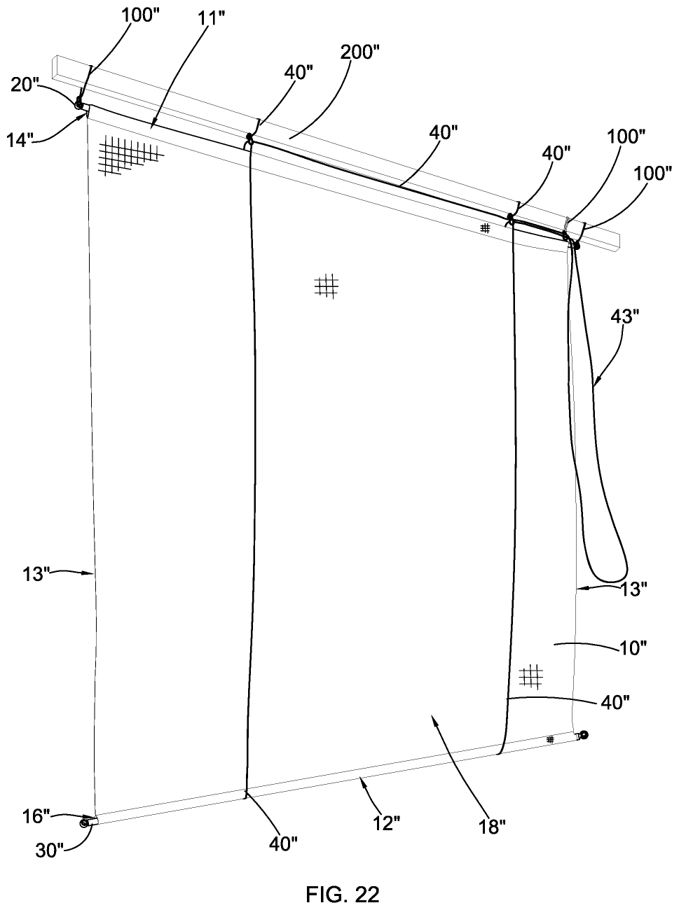

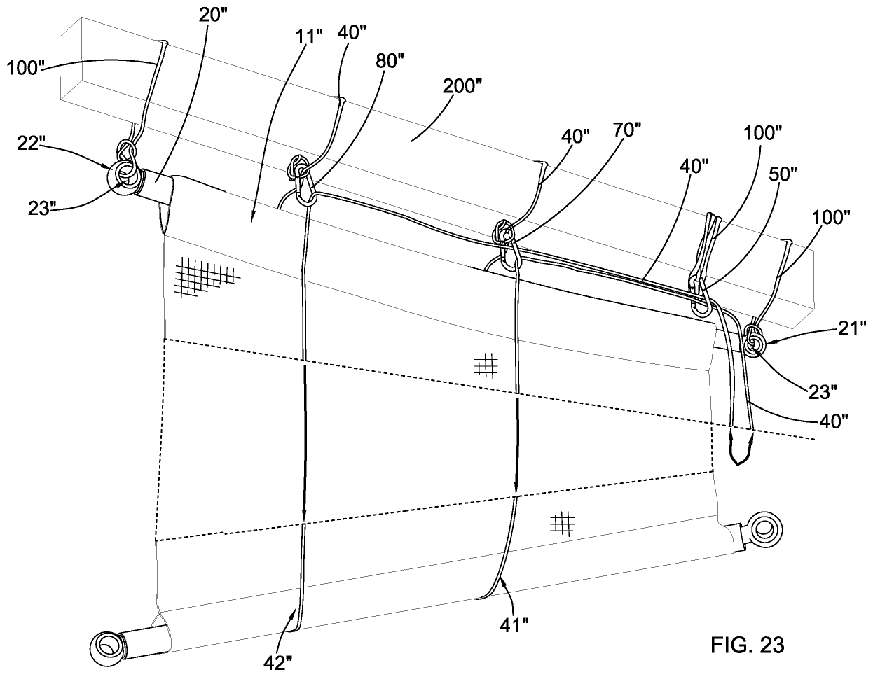

Referring to FIG. 22 and FIG. 23 of the drawings, an alternative mode of the curtain assembly according to the second preferred embodiment of the present invention is illustrated. The alternative mode is very similar to the second preferred embodiment described above. The only difference is that the alternative mode omits the second coupling member 60″ so that the connecting cord 40″ only passes through the first coupling member 50″, the third coupling member 70″ and the fourth coupling member 80″.

The connecting cord 40″ may pass through the first coupling member 50″ to form the handle loop 43″. A section (such as a first section 41″) of the connecting cord 40″ passing through the first coupling hole 51″ may extend to pass through the third guiding hole 71″ of the third coupling member 70″ and extend around the curtain fabric 10″ from the front surface 18″ to the rear surface 19″ and connect with an external support, such as a horizontal bar 200″.

Another section (such as a second section 42″) of the connecting cord 40″ passing through the second coupling hole 61″ of the second coupling member 60″ may be arranged to pass through the fourth guiding hole 81″ of the fourth coupling member 80″ and extend around the curtain fabric 10″ from the front surface 18″ to the rear surface 19″ and connect with an external support, such as a horizontal bar 200″.

Referring to FIG. 23 of the drawings, it is worth mentioning that the first supporting end portion 21″ and the second supporting end portion 22″ of the upper supporting shaft 20″ may form a hole 23″ wherein the mounting cable 100″ may fasten on the holes 23″ so as to fasten the upper supporting shaft 20″ on the external support, such as the horizontal bar 100″.

The curtain assembly of the present invention may be operated between a shading position and a retracted position, wherein in the shading position, the curtain fabric 10″ is fully extended between the upper supporting shaft 20″ and the lower supporting shaft 30″, wherein in the retracted position, the handle loop 43″ may be pulled and retained to pull the lower supporting shaft 30″ and roll the curtain fabric 10″ toward the upper supporting shaft 20″ so as to allow the curtain fabric 10″ to be retracted and form a roll and form a compact structure.

The structure of all other components of the curtain assembly remains identical to that disclosed in the second preferred embodiment above.

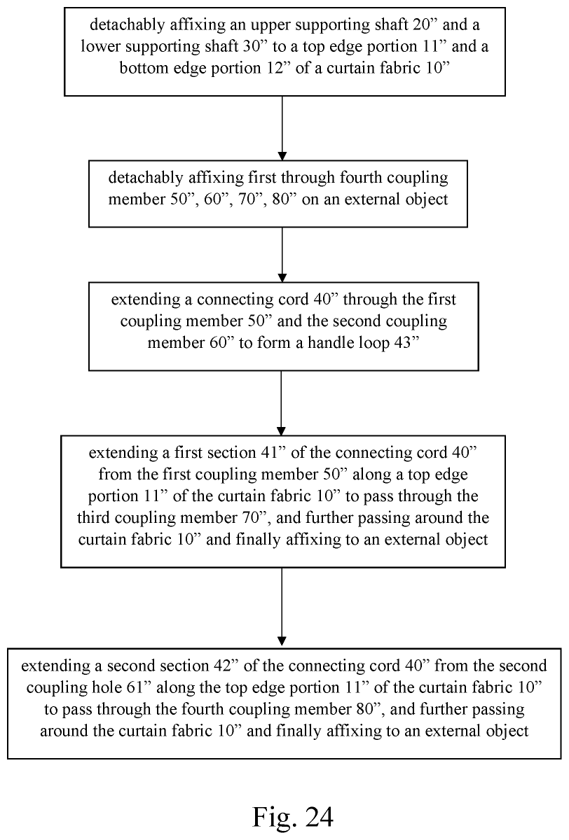

According the second preferred embodiment of the present invention, and referring to FIG. 24 of the drawings, the present invention also provides a method of assembling a curtain assembly, comprising the steps of:
(a) detachably affixing an upper supporting shaft 20″ and a lower supporting shaft 30″ to a top edge portion 11″ and a bottom edge portion 12″ of a curtain fabric 10″ respectively;
(b) detachably affixing a first coupling member 50″, a second coupling member 60″, a third coupling member 70″ and a fourth coupling member 80″ on an external object the first coupling member 50″ having a first guiding hole 51″, the second coupling member 60″ having a second guiding hole 61″, the third coupling member 70″ having a third guiding hole 71″, and the fourth coupling member 80″ having a fourth guiding hole 81″;
(c) extending a connecting cord 40″ through the first coupling member 50″ and the second coupling member 60″ to form a handle loop 43″;
(d) extending a first section 41″ of the connecting cord 40″ from the first coupling hole 51″ along the top edge portion 11″ of the curtain fabric 10″ to pass through the third coupling hole 71″ of the third coupling member 70″, and further passing around the curtain fabric 10″ and finally affixing to an external object; and
(e) extending a second section 42″ of the connecting cord 40″ from the second coupling hole 61″ along the top edge portion 11″ of the curtain fabric 10″ to pass through the fourth coupling hole 81″ of the fourth coupling member 80″, and further passing around the curtain fabric 10″ and finally affixing to an external object.

The method of assembling a certain assembly may further comprise a step, between step (a) and step (b), of fastening the upper supporting shaft 20″ to an external object, such as a horizontal bar in a patio.

Step (a) may comprise the steps of:
(a.1) forming an upper elongated slot 14″ along an upper edge portion 11″ of the curtain fabric 10″; and
(a.2) detachably inserting the upper supporting shaft 20″ through the upper elongated slot 14″ so as to detachably affixing an upper supporting shaft 20″ to the top edge portion 11″ of the curtain fabric 10″;
(a.3) forming a lower elongated slot 16″ along a bottom edge portion 12″ of the curtain fabric 10″; and
(a.4) detachably inserting the lower supporting shaft 30″ through the lower elongated slot 16″ so as to detachably affixing the lower supporting shaft 30″ to the bottom edge portion 12″ of the curtain fabric 10″.

In step (c), one end of the connecting cord 40″ may pass the first coupling hole 51″ and extend downwardly to a certain length, and go back up to pass through the second coupling hole 61″ for forming the handle loop 43″ which is the portion of the connecting cord 40″ extending between the first coupling hole 51″ and the second coupling hole 61″.

In step (d), the connecting cord 40″ which passes through the first coupling hole 51″ may extend along a horizontal direction of the curtain fabric 10″ (i.e. along a direction substantially parallel to the top edge portion 11″) and pass through the third coupling hole 71″. After that, the connecting cord 40″ may go on to extend downwardly along the front surface 18″ of the curtain fabric 10″ and reach the bottom edge portion 12″ thereof. The connecting cord 40″ may then go around the bottom edge portion 12″ and extend back up along the rear surface 19″ of the curtain fabric 10″. After that, the connecting cord 40″ may be fastened to an external object, such as the horizontal bar, as well as the third coupling member 70″. The purpose is to secure the position of the third coupling member 70″ above the curtain fabric 10″.

In step (e), the connecting cord 40″ which passes through the second coupling hole 61″ may extend along a horizontal direction of the curtain fabric 10″ (i.e. along a direction substantially parallel to the top edge portion 11″) and pass through the fourth coupling hole 81″ (preferably via the third coupling hole 71″). After that, the connecting cord 40″ may go on to extend downwardly along the front surface 18″ of the curtain fabric 10″ and reach the bottom edge portion 12″ thereof. The connecting cord 40″ may then go around the bottom edge portion 12″ and extend back up along the rear surface 19″ of the curtain fabric 10″. After that, the connecting cord 40″ may be fastened to an external object, such as the horizontal bar, as well as the fourth coupling member 80″. The purpose is to secure the position of the fourth coupling member 80″ above the curtain fabric 10″.

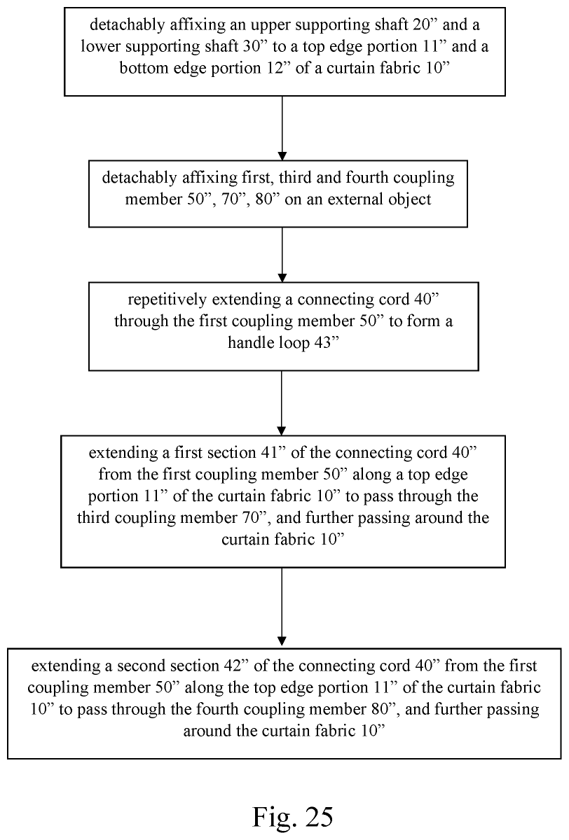

Referring to FIG. 25 of the drawings, in the alternative mode of the second preferred embodiment described above, the method of assembling a curtain assembly may be slightly amended to comprise the steps of:
(1) detachably affixing an upper supporting shaft 20″ and a lower supporting shaft 30″ to a top edge portion 11″ and a bottom edge portion 12″ of a curtain fabric 10″ respectively;
(2) detachably affixing a first coupling member 50″, a third coupling member 70″ and a fourth coupling member 80″ on an external object, the first coupling member 50″ having a first guiding hole 51″, the third coupling member 70″ having a third guiding hole 71″, and the fourth coupling member 80″ having a fourth guiding hole 81″;
(3) repetitively extending a connecting cord 40″ through the first coupling member 50″ to form a handle loop 43″;
(4) extending a first section 41″ of the connecting cord 40″ from the first coupling hole 51″ along the top edge portion 11″ of the curtain fabric 10″ to pass through the third coupling hole 71″ of the third coupling member 70″, and further passing around the curtain fabric 10″ and finally affixing to an external object; and
(5) extending a second section 42″ of the connecting cord 40″ from the first coupling hole 51″ along the top edge portion 11″ of the curtain fabric 10″ to pass through the fourth coupling hole 81″ of the fourth coupling member 80″, and further passing around the curtain fabric 10″ and finally affixing to an external object.

In step (3), one end of the connecting cord 40″ may pass the first coupling hole 51″ and extend downwardly to a certain length, and go back up to pass through the first coupling hole 51″ again for forming the handle loop 43″ which is the portion of the connecting cord 40″ extending through and below the first coupling hole 51″.

In step (4), the first section 41″ of the connecting cord 40″ which passes through the first coupling hole 51″ may extend along a horizontal direction of the curtain fabric 10″ (i.e. along a direction substantially parallel to the top edge portion 11″) and pass through the third coupling hole 71″. After that, the connecting cord 40″ may go on to extend downwardly along the front surface 18″ of the curtain fabric 10″ and reach the bottom edge portion 12″ thereof. The connecting cord 40″ may then go around the bottom edge portion 12″ and extend back up along the rear surface 19″ of the curtain fabric 10″. After that, the connecting cord 40″ may be fastened to an external object, such as the horizontal bar, or to the third coupling member 70″. The purpose is to secure the position of the third coupling member 70″ above the curtain fabric 10″.

In step (5), the second section 42″ of the connecting cord 40″ which passes through the first coupling hole 51″ may extend along a horizontal direction of the curtain fabric 10″ (i.e. along a direction substantially parallel to the top edge portion 11″) and pass through the fourth coupling hole 81″ (preferably via the third coupling hole 71″). After that, the connecting cord 40″ may go on to extend downwardly along the front surface 18″ of the curtain fabric 10″ and reach the bottom edge portion 12″ thereof. The connecting cord 40″ may then go around the bottom edge portion 12″ and extend back up along the rear surface 19″ of the curtain fabric 10″. After that, the connecting cord 40″ may be fastened to an external object, such as the horizontal bar, or the fourth coupling member 80″. Again, the purpose is to secure the position of the fourth coupling member 80″ above the curtain fabric 10″.

The operation of the present invention may be described as follows: the curtain assembly may be operated between a shading position and a retracted position. When it is in the shading position, the curtain fabric 10″ may be fully extended. The curtain fabric 10″ may then provide effective shading to sunlight.

When the curtain assembly is in the retracted position, the handle loop 43″ may be pulled so that connecting cord 40″ may retract to move the lower supporting shaft 30″ toward the upper supporting shaft 20″. At the same time, when the lower supporting shaft 30″ is pulled upwardly, the corresponding portion of the curtain fabric 10″ may be rolled about the lower supporting shaft 30″ until the lower supporting shaft 30″ reaches the upper supporting shaft 20″. A user may be required to fasten the handle loop 43″ to an external object, such as an external column in a patio to retain the curtain assembly in the retracted position.

The present invention, while illustrated and described in terms of a preferred embodiment and several alternatives, is not limited to the particular description contained in this specification. Additional alternative or equivalent components could also be used to practice the present invention.

What is claimed is:

1. A curtain assembly, comprising:
a curtain fabric having a front surface, a rear surface, a top edge portion, a bottom edge portion, and two side edge portions extending between said top edge portion and said bottom edge portion;
an upper supporting shaft coupled to said top edge portion, said upper supporting shaft having a first supporting end portion and a second supporting end portion, and being suspendedly affixed to an external support;
a lower supporting shaft coupled to said bottom edge portion of said curtain fabric;
first and second coupling member having a first guiding hole and a second guiding hole respectively, said first coupling member and said second coupling member spacedly being supported above said first supporting end portion of said upper supporting shaft;
a third coupling member having a third guiding hole, and being supported above said upper supporting shaft;
a fourth coupling member having a fourth guiding hole, and being supported above said upper supporting shaft at a position spaced apart from said third coupling member;
a connecting cord sequentially extending between said first coupling member and said second coupling member to form a handle loop, said connecting cord passing through said first guiding hole extending to pass through said third guiding hole and extend around said curtain fabric from said front surface to said rear surface,
said connecting cord passing through said second guiding hole being arranged to pass through said fourth guiding hole and extend around said curtain fabric from said front surface to said rear surface;
said curtain assembly being operated between a shading position and a retracted position, wherein in said shading position, said curtain fabric is fully extended between said upper supporting shaft and said lower supporting shaft, wherein in said retracted position, said handle loop is pulled and retained to pull said lower supporting shaft and roll said curtain fabric toward said upper supporting shaft so as to allow said curtain fabric to be retracted and form a roll.

2. The curtain assembly, as recited in claim 1, wherein said curtain fabric has an upper elongated slot extending along said top edge portion so that said upper supporting shaft is allowed to pass through said upper elongated slot.

3. The curtain assembly, as recited in claim 2, wherein said curtain fabric further has a lower elongated slot extending along said bottom edge portion so that said lower supporting shaft is allowed to pass through said lower elongated slot.

4. The curtain assembly, as recited in claim 3, wherein said first coupling member comprises a first main frame and a first pin member pivotally connected to said first main frame, said first main frame being bent to form a first loop having a first opening, wherein said first pin member is pivotally connected to said first main frame to selectively close and open said first opening.

5. The curtain assembly, as recited in claim 4, wherein said second coupling member comprises a second main frame and a second pin member pivotally connected to said second main frame, said second main frame being bent to form a second loop having a second opening, wherein said second pin member is pivotally connected to said second main frame to selectively close and open said second opening.

6. The curtain assembly, as recited in claim 5, wherein said third coupling member comprises a third main frame and a third pin member pivotally connected to said third main frame, said third main frame being bent to form a third loop having a third opening, wherein said third pin member is pivotally connected to said third main frame to selectively close and open said third opening.

7. The curtain assembly, as recited in claim 6, wherein said fourth coupling member comprises a fourth main frame and a fourth pin member pivotally connected to said fourth main frame, said fourth main frame being bent to form a fourth loop having a fourth opening, wherein said fourth pin member is pivotally connected to said fourth main frame to selectively close and open said fourth opening.

8. The curtain assembly, as recited in claim 7, wherein said connecting cord is arranged to pass through said third guiding hole when extending from said second guiding hole toward said fourth guiding hole, so that said third coupling member serves as an intermediate support for said connecting cord.

9. A method of assembling a curtain assembly, comprising the steps of:
(a) detachably affixing an upper supporting shaft and a lower supporting shaft to a top edge portion and a bottom edge portion of a curtain fabric respectively;
(b) detachably affixing a first coupling member, a second coupling member, a third coupling member and a fourth coupling member on an external object said first coupling member having a first guiding hole, said second coupling member having a second guiding hole, said third coupling member having a third guiding hole, and said fourth coupling member having a fourth guiding hole;
(c) extending a connecting cord through said first coupling member and said second coupling member to form a handle loop;
(d) extending a first section of said connecting cord from said first coupling hole along said top edge portion of said curtain fabric to pass through said third coupling hole of said third coupling member, and further passing around said curtain fabric and finally affixing to an external object; and
(e) extending a second section of said connecting cord from said second coupling hole along said top edge portion of said curtain fabric to pass through said fourth coupling hole of said fourth coupling member, and further passing around said curtain fabric and finally affixing to an external object.

10. The method, as recited in claim 9, wherein said step (a) comprises the steps of:
(a.1) forming an upper elongated slot along an upper edge portion of said curtain fabric; and
(a.2) detachably inserting said upper supporting shaft through said upper elongated slot so as to detachably affixing an upper supporting shaft to said top edge portion of said curtain fabric;
(a.3) forming a lower elongated slot along a bottom edge portion of said curtain fabric; and
(a.4) detachably inserting said lower supporting shaft through said lower elongated slot so as to detachably affixing said lower supporting shaft to said bottom edge portion of said curtain fabric.

11. The method, as recited in claim 10, wherein said step (d) comprises the steps of:
passing a first section of said connecting cord through said first coupling hole;
extending said first section of said connecting cord along a horizontal direction of said curtain fabric;
passing said first section of said connecting cord through said third coupling hole;
extending said first section of said connecting cord downwardly along one of a front surface and a rear surface of said curtain fabric to reach said bottom edge portion thereof;
extending said first section connecting cord around said bottom edge portion of said curtain fabric and extending said first section of said connecting cord up along another front surface and said rear surface of said curtain fabric; and
fastening said first section of said connecting cord to an external object.

12. The method, as recited in claim 11, wherein said step (e) comprises the steps of:
passing a second section of said connecting cord through said second coupling hole;
extending said second section of said connecting cord along a horizontal direction of said curtain fabric;
passing said second section of said connecting cord through said third coupling hole, and continuously extending said second section of said connecting cord along a horizontal direction of said curtain fabric;
passing said second section of said connecting cord through said fourth coupling hole;
extending said second section of said connecting cord downwardly along one of a front surface and said rear surface of said curtain fabric to reach said bottom edge portion thereof;
extending said second section connecting cord around said bottom edge portion of said curtain fabric and extending said second section of said connecting cord up along one another of said front surface and said rear surface of said curtain fabric; and
fastening said second section of said connecting cord to an external object.

13. The method, as recited in claim 9, further comprising a step, between said step (a) and said step (b), of fastening said upper supporting shaft to an external object.

14. The method, as recited in claim 12, further comprising a step, between said step (a) and said step (b), of fastening said upper supporting shaft to an external object.

15. A curtain assembly, being manufactured by a method comprising the steps of:
(a) detachably affixing an upper supporting shaft and a lower supporting shaft to a top edge portion and a bottom edge portion of a curtain fabric respectively;
(b) detachably affixing a first coupling member, a second coupling member, a third coupling member and a fourth coupling member on an external object said first coupling member having a first guiding hole, said second coupling member having a second guiding hole, said third coupling member having a third guiding hole, and said fourth coupling member having a fourth guiding hole;
(c) extending a connecting cord through said first coupling member and said second coupling member to form a handle loop;
(d) extending a first section of said connecting cord from said first coupling hole along said top edge portion of said curtain fabric to pass through said third coupling hole of said third coupling member, and further passing around said curtain fabric and finally affixing to an external object; and
(e) extending a second section of said connecting cord from said second coupling hole along said top edge portion of said curtain fabric to pass through said fourth coupling hole of said fourth coupling member, and further passing around said curtain fabric and finally affixing to an external object.

16. A curtain assembly, comprising:
a curtain fabric having a front surface, a rear surface, a top edge portion, a bottom edge portion, and two side edge portions extending between said top edge portion and said bottom edge portion;
an upper supporting shaft coupled to said top edge portion, said upper supporting shaft having a first supporting end portion and a second supporting end portion, and being suspendedly affixed to an external support;
a lower supporting shaft coupled to said bottom edge portion of said curtain fabric;
a first coupling member having a first guiding hole, said first coupling member being supported above said first supporting end portion of said upper supporting shaft;
a third coupling member having a third guiding hole, and being supported above said upper supporting shaft;
a fourth coupling member having a fourth guiding hole, and being supported above said upper supporting shaft at a position spaced apart from said third coupling member;
a connecting cord repetitively through said first coupling member to form a handle loop, a first section of said connecting cord passing through said first guiding hole extending to pass through said third guiding hole and extend around said curtain fabric from said front surface to said rear surface,
a second section of said connecting cord passing through said second guiding hole being arranged to pass through said fourth guiding hole and extend around said curtain fabric from said front surface to said rear surface;
said curtain assembly being operated between a shading position and a retracted position, wherein in said shading position, said curtain fabric is fully extended between said upper supporting shaft and said lower supporting shaft, wherein in said retracted position, said handle loop is pulled and retained to pull said lower supporting shaft and roll said curtain fabric toward said upper supporting shaft so as to allow said curtain fabric to be retracted and form a roll.

17. A curtain assembly, being manufactured by a method comprising the steps of:
(1) detachably affixing an upper supporting shaft and a lower supporting shaft to a top edge portion and a bottom edge portion of a curtain fabric respectively;
(2) detachably affixing a first coupling member, a third coupling member and a fourth coupling member on an external object said first coupling member having a first guiding hole, said third coupling member having a third guiding hole, and said fourth coupling member having a fourth guiding hole;
(3) repetitively extending a connecting cord through said first coupling member to form a handle loop;
(4) extending a first section of said connecting cord from said first coupling hole along said top edge portion of said curtain fabric to pass through said third coupling hole of said third coupling member, and further passing around said curtain fabric; and
(5) extending a second section of said connecting cord from said first coupling hole along said top edge portion of said curtain fabric to pass through said fourth coupling hole of said fourth coupling member, and further passing around said curtain fabric.
